(19) United States
(12) Patent Application Publication
(10) Pub. No.: US 2004/0035770 A1
(43) Pub. Date: Feb. 26, 2004

(54) Dynamically responsive aerobic to anoxic inter-zone flow control system for single vessel multi-zone bioreactor wastewater treatment plants

(76) Inventors: Haskell L. Edwards, Minden, NV (US); Kaspar A. Kasparian, Raleigh, NC (US)

Correspondence Address: MILLS LAW FIRM PLLC, P.O. Box 1088, Wake Forest, NC, 27588, US

(21) Appl. No.: 10/227,585

(22) Filed: Aug. 26, 2002

(51) Int. Cl. B01D 17/12

(52) U.S. Cl. 210/137; 210/96.1; 210/151; 210/614

(57) ABSTRACT

An inter-zone aerobic to anoxic zone flow rate control system for single vessel multi-zone bioreactor plants for wastewater treatment is described herein. The system of the invention provides control of the relative treatment times of the mixed liquor in the horizontally disposed and adjacent aerobic and anoxic treatment zones of the bioreactor by providing one or more flow rate adjusting gates located between the aerobic and anoxic zones of the bioreactor. The opening of the gates is adjustable in accordance with sensed conditions in the treatment zones. An automated embodiment of the invention includes a programmable logic controller that provides control scripts for adjusting the opening of one or more flow control gates according to inputs from sensors and per programmed instructions. An automated and supervised embodiment of the invention includes a computer interfaced with a programmable automating controller. The computer provides status reports, commands to the programmable automating controller, storage and analysis of data, as well as a means of communicating to remote monitoring centers and networks.

### FIELD OF THE INVENTION

This invention is related to biological wastewater treatment. More specifically, it pertains to biological wastewater treatment in a single vessel multi-zone bioreactor with horizontally adjacent aerobic, anoxic and clarification treatment zones.

### BACKGROUND OF THE INVENTION

Single vessel integrated multi-zone bioreactors with upper horizontally adjacent aerobic, anoxic and clarification zones are currently being tested for various biological wastewater treatment applications. Those single vessel bioreactors are vertical cylindrical vessels that perform wastewater treatment using an integrated design that incorporates multiple biological treatment environments within one vessel. The upper portion of the cylindrical bioreactors includes an innermost aerobic treatment zone, a horizontally adjacent concentric anoxic treatment zone and an outermost concentric clarification zone. The upper zones of those bioreactors are normally formed by fixed baffles or separations that extend from the top of the cylindrical vessel to a middle facultative zone to define the upper concentric zones. Underneath the facultative zone there normally is an anaerobic treatment zone with a lower sludge zone. Upon stabilization, such a configuration with the above treatment zones creates favourable conditions for the population and diversity of microflora that is involved in this biological wastewater treatment process, with the advantage that the entire treatment is carried out in one vessel.

A single vessel multi-zone bioreactor for wastewater treatment with the above configuration and the above treatment zones is hereinafter referred to as a SVMB. The SVMB has the appeal of a simple, fixed design and can be employed for predefined wastewater treatment applications with relatively stable influent characteristics that do not adversely disturb its various biological environments. However, in many applications, SVMBs will have to cope with criteria far beyond predefined variations, as in the case of the overflow of municipal sewer lines that overwhelm municipal wastewater treatment plants during heavy rainfall.

Thus, one criterion of concern for SVMBs is an anecdotal instability of the flow rate of the influent. As with other treatment systems, a stabilization basin preceding the SVMB can act as a buffer and helps to stabilize the effects of incidental flow rate variations.

Bigger challenges for SVMBs are applications where the influent characteristics, by the inherent nature of the influent source, undergo constant changes, including constant destabilizing changes in influent characteristics that are beyond what a fixed design SVMB can accommodate. The constant destabilizing changes adversely affect the action of the specialized microorganisms that require specific environments for their diversity, distribution and processing action.

It was also recently discovered that the relative treatment times (retention times) of the mixture of liquids and suspended solids in the aerobic zone and the anoxic zones of a SVMB have a major impact on the overall effectiveness, stability and performance of such wastewater treatment plants.

In addition, SVMB plants require some time to “stabilize” after being put into initial operation, after interruptions in operation and after upheavals of influent characteristics, before producing the desired effluent quality. Often, after influent upheavals, the process of stabilization can take 4-5 weeks. The stabilization delay is caused by the inherent nature of SVMBs where the ideal distribution and quantity of the diverse microorganisms involved in the processing of wastewater take time to reach the level and distribution needed in the single vessel for proper processing of the wastewater. Long stabilization periods are generally undesirable and occur more frequently when influent upheavals are encountered from varied batch processes that produce disturbances in the characteristics of the wastewater being treated. Yet, many industries that produce wastewater are involved in batch processing, such as food processing industries, pharmaceutical industries, distillers, dairy industries and slaughterhouses.

Thus, it would be advantageous and a requirement for a more versatile and adaptive SVMB to a) constantly adapt to fluctuating influent characteristics, b) stabilize faster after influent upheavals and c) control relative retention (treatment) times in its aerobic and anoxic treatment zones. The problems related to meeting the aforementioned requirements have been discovered to emanate from non-adaptive, uncontrolled and varying circulation rates of the mixed liquor (the fluid with a culture of microorganisms—a mixture of liquid and lighter biosolids that have not settled into the lower zones of the vessel) in and around the aerobic and anoxic zones of SVMBs, which in turn affects the relative treatment (retention) times in those zones, the Dissolved Oxygen (DO) environments that must be maintained in each of those zones and the stabilization times required after destabilizations for proper treatment of the influent.

### OBJECT OF THE INVENTION

It is an object of the invention to provide a dynamically responsive aerobic to anoxic interzone flow control system for SVMB plants for the purpose of improving their adaptability to fluctuating influent characteristics, achieving faster stabilization after influent upheavals and controlling relative retention (treatment) times in their aerobic and anoxic treatment zones.

### SUMMARY OF THE INVENTION

More specifically, in accordance with the present invention, there is provided an inter-zone flow rate control system for single vessel multi-zone bioreactor wastewater treatment plants with horizontally adjacent upper aerobic and anoxic zones; said inter-zone flow rate control system comprising at least one flow rate adjusting device provided between the aerobic and anoxic zones; said flow rate adjusting device controlling a flow rate of mixed liquor between the aerobic and anoxic zones; at least one sensor mounted in the single vessel multi-zone bioreactor to monitor a characteristic thereof; wherein said flow rate adjusting device is so adjusted as to control the flow rate of the mixed liquor according to data gathered by said at least one sensor.

It is to be understood herein and in the appended claims that the word “gate” is to be construed as meaning any adequate means or element for adjusting flow and the flow rate, such as valves, gates and other adjustable opening flow rate controlling devices.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a schematic top plan view of a SVMB incorporating an aerobic to anoxic zone bypass flow control system according to an embodiment of the present invention;

FIG. 2 is a schematic partly sectional perspective view of a portion of a SVMB incorporating an aerobic to anoxic zone bypass flow control system according to an embodiment of the present invention;

FIG. 3 is a schematic partly sectional perspective view of a portion of a SVMB incorporating an aerobic to anoxic zone bypass flow control system according to another embodiment of the present invention;

FIG. 4 is a sectional side elevational view of a SVMB incorporating an aerobic to anoxic zone bypass flow control system according to another embodiment of the present invention;

FIG. 5 is a flowchart illustrating an algorithm for the control and coordination of an inter-zone flow control gate and of an oxygenation blower; and

FIG. 6 is a flowchart illustrating further algorithm details for the control of both Dissolved Oxygen and retention time through coordination of an SVMB's oxygenation blower and an inter-zone flow control gate system.

### DESCRIPTION OF THE PREFERRED EMBODIMENT

The system of the invention generally provides a solution for all of the requirements mentioned in the section “Background of the invention” through an inter-zone aerobic to anoxic zone bypass flow control system. The system of the invention addresses all the aforementioned requirements in several embodiments and provides a new means of dynamically responding to changing characteristics of the vessel's influent, achieving faster stabilization after influent upheavals, while maintaining desirable average retention times in the aerobic and anoxic zones of the SVMB.

It was discovered that the respective retention times in the aerobic and anoxic treatment zones of SVMBs could be affected by adding one or more openings on the baffle separating the aerobic and anoxic treatment zones. Such openings produced inter-zone bypass flow of mixed liquor from the aerobic zone into the anoxic zone and thus affected the respective retention times in those zones. It was then discovered that the openings not only provided a means of affecting the relative processing times in the aerobic and anoxic zones, but also provided a means of controlling the amount of Dissolved Oxygen (DO) in the critical anoxic treatment zone. This was attributed to the influx of Oxygen-laden aerobic mixed liquor into the anoxic zone through the inter-zone openings. The oxygenation blowers used for adding Oxygen to the aerobic zone do not directly affect or adequately control the critical Dissolved Oxygen levels (0.1 to 0.3 mg/l) that must be maintained in the anoxic zone for proper treatment.

From the aforementioned observations ensued the realization of the basic embodiment of the present invention in which manual or power-assisted adjustment of one or more inter-zone openings, such as adjustment of the openings of inter-zone gates according to sensed Dissolved Oxygen readings in the anoxic zone, resulted in an overall processing that is much more responsive to variations in the influent characteristics. At the same time, the inter-zone flow control system is used for fostering desirable average retention times in the aerobic and anoxic zones of a SVMB wastewater treatment plant by controlling the inter-zone flow rates between those zones. It was discovered that the tighter control of respective retention times and Dissolved Oxygen in the anoxic zone also significantly reduces stabilization time after influent upheavals or interruptions due to the maintenance of ideal treatment environments and times for the microorganisms to perform their biological tasks.

In practical SVMB tests, it was recently confirmed that there are two critical factors that profoundly affect the performance and adaptability of SVMB plants. One factor is control of the respective treatment (retention) time in each of the aerobic and anoxic zones. The other factor is a requirement of maintaining a tight control of the Dissolved Oxygen in the anoxic zone. Fortunately, the two requirements can be addressed by the common solutions provided by the system of the invention, since they are inter-related, as will be understood by the foregoing description.

It was realized that a desirable cycle for treatment in the aerobic and anoxic zones is treatment of the mixed liquor for about one third of the retention time in the aerobic zone and about two-thirds of the retention time in the anoxic zone. Thus the ratio of retention time in the aerobic and anoxic zones is ½. In a practical 30 minute cycle of turning over the mixed liquor in the aerobic and anoxic zones, the aforementioned ratios translate into a predetermined desirable retention time of 10 minutes for the treatment in the aerobic zone and a predetermined retention time of 20 minutes for the treatment in the anoxic zone. However, maintaining desirable average retention times in the aerobic and anoxic zones is not best served by fixed baffle designs which cannot dynamically respond and adapt to changing influent characteristics and influent upheavals to control respective retention times in the aerobic and anoxic zones of a SVMB. It was realized that improper average retention times in aerobic and anoxic zones also ultimately result in abnormal Dissolved Oxygen levels in the anoxic zone and poor effluent quality.

The present invention is thereby generally concerned with an inter-zone bypass flow control system with at least one flow rate adjusting device in the form of adjustable opening gates that are used to adjust the interzone flow rate of mixed liquor from an aerobic zone to an adjacent anoxic treatment zone of SVMB wastewater treatment plants. The inter-zone flow rate is adjusted in response to sensed conditions pertaining to the treatment requirements in the bioreactor, such as DO levels in its anoxic zone and the respective retention times in its aerobic and anoxic zones as measured by sensors, such as flow rate sensors.

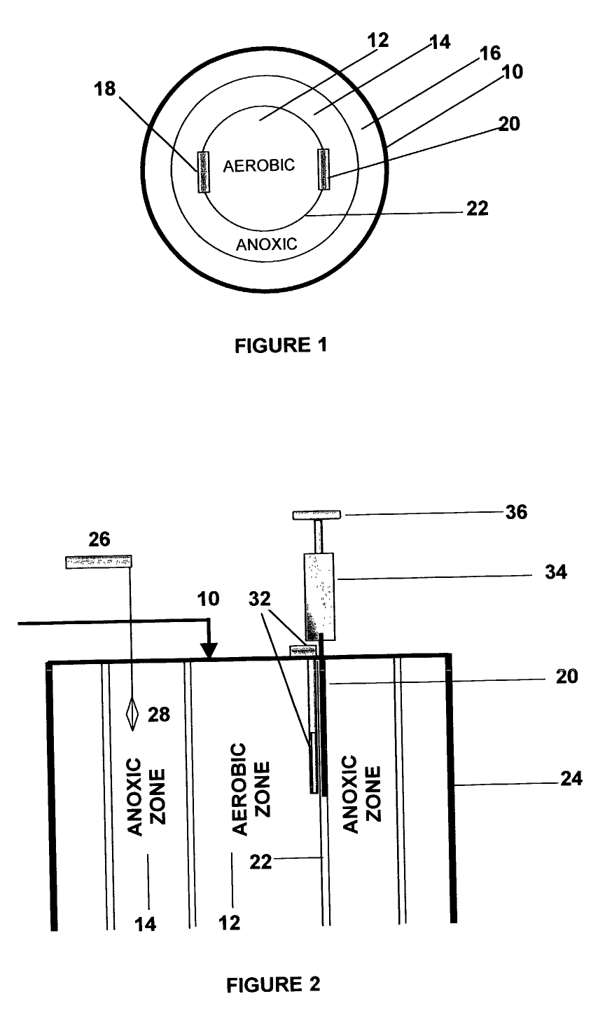

Generally stated, as can be seen from FIG. 1 which schematically illustrates a SVMB 10, including an aerobic to anoxic zone bypass flow control system according to the general principles of the present invention, the innermost upper circular portion of the SVMB 10 is an aerobic treatment zone 12 that is designed for intake of the influent from above (not shown). To maintain aerobic conditions, the aerobic zone receives air at its bottom from an oxygenation blower (not shown) whose speed can be adjusted to control the amount of air delivered.

The aerobic zone 12 performs various wastewater treatment functions through the action of microbes that degrade and solubilize COD (Chemical Oxygen Demand), breaking long chain carbon compounds into easily degradable substrates. However, that aerobic treatment produces nitrate nitrogen that requires denitrification, which is then accomplished in the upper adjacent anoxic zone 14 that is the circular portion next to the aerobic portion 12 and generally concentric therewith. The outermost circular portion is a clarification zone 16 formed by the outer wall of the anoxic zone and the outer wall of the SVMB vessel 10.

FIG. 1 also schematically illustrates two inter-zone flow control gates 18 and 20 provided between the aerobic zone 12 and the anoxic zone 14 and that can be physically installed in a properly cut out and, if necessary, reinforced section of an inter-zone baffle 22 or other physical separation between zones 12 and 14. Physical separations between zones 12 and 14 normally extend vertically from the upper portion of the bioreactor vessel 10 down to the middle facultative area or thereabouts. Multiple interzone flow control gates can be used to produce less turbulence at any given point and to foster a better uniformity of the properties of the mixed liquor in the anoxic zone by spreading out the inter-zone flow control points.

It is to be noted that, in the appended drawings, similar reference numbers are used to reference similar elements.

FIG. 2 is a schematic partly sectional perspective view of a SVMB 24, used for wastewater treatment, incorporating an embodiment of the present invention. For clarity purposes, the lower facultative and lowest anaerobic and sludge zones of the SVMB plant, as well as the auxiliary equipment of the SVMB are not shown in FIG. 2.

The SVMB 24 includes a manually operated or a power-assisted inter-zone gate 20 that adjusts the bypass flow rate of mixed liquor from the upper aerobic zone 12 to the anoxic zone 14. Inter-zone gate 20 is disposed between the aerobic and anoxic zone, normally at about 1 meter (about 3.3 feet) below the liquid level, since that is the point where the DO level must be between 0.1 and 0.3 mg/l for maintaining a proper anoxic treatment environment. The inter-zone gate 20 is adjusted according to the readings of a Dissolved Oxygen monitor 26 mounted in the anoxic zone 14 and including a sensor 28, as well as other monitored parameters, such as the flow rate between the zones as monitored by a flow rate monitor 32.

Achieving predetermined retention times in the aerobic and anoxic zones 12 and 14 is addressed by incorporating the variable opening inter-zone gate 20 between these zones. The inter-zone gate 20 is adjusted by means of a manual or power assisted mechanism 34 (a manual mechanism being shown in FIG. 2) until the inter-zone flow rate, as measured by the flow rate monitor 32, corresponds to that required for desirable average respective retention times of the mixed liquor in the aerobic and anoxic zones 12 and 14.

The opening of inter-zone gate 20 at the point where predetermined average desirable retention times are achieved becomes the default setting of the inter-zone gate 20. The inter-zone flow rate at the default setting of gate 20 that produces a desirable average retention time is recorded with the help of the flow rate monitor 32 as the default inter-zone flow rate. Thereafter, fine adjustments on the retention times in the aerobic and anoxic treatment zones are affected by adjusting the inter-zone flow opening of gate 20 from its default setting, in response to flow rate changes that deviate from the default flow rate.

As will easily be understood by one skilled in the art, the illustrated mechanism 34 adjusts the opening and closing positions of inter-zone gate 20 manually, by means of control wheel 36. Alternatively, the controller 34 can also be an electrically, pneumatically or hydraulically power-assisted controller.

It is to be noted that the type of inter-zone gate that is used depends on the preferred response characteristics of the gate. For example, an inter-zone flow control system using a variable circular gate (iris type gate) can be used when a “squared” response is required for a given change in radius of the circular opening. To illustrate, if the inter-zone gate of the system of the invention is opened from a circular radius of 15 inches to a double circular radius of 30 inches, then the area of flow with the 15 inch radius opening would be approximately 707 square inches and the area of flow with the 30 inch radius opening would be 2827 square inches or quadruple of the flow area compared to the 15 inch radius opening.

For a better understanding of FIG. 2, the following illustrative data relates to the design of a full-scale SVMB plant that has to treat wastewater from a slaughterhouse. Engineering considerations for the illustrative SVMB plant for treating slaughterhouse wastewater can include the following:

| | | |
|---|---|---|
| Flow: | 650 | m³/day. |
| BOD (Biocehmical Oxygen Demand): | 1000 | mg/l |
| Reactor organic loading rate: | 650 | kg/day |
| Reactor design criteria: | 2 | kg/m³ |
| Reactor volume: | 325 | m³ |
| Aerobic reactor ⅓ (10 minutes): | 108 | m³ |
| Anoxic reactor ⅔ (20 minutes): | 217 | m³ |
| Resultant reactor diameter and height: | | |
| Aerobic portion | 17 | feet × 17 feet |
| Anoxic portion | 24 | feet × 17 feet |

Based on the above volume and the need to control the turn over of the mixed liquor contents every 30 minutes, one technique would be to provide a sufficient number and size of fixed orifices to the baffle 22 separating the upper aerobic and anoxic zones 12 and 14.

The orifices can illustratively be designed to allow 13600 liters (about 3000 gallons) per minute to flow from the aerobic zone directly to the adjacent anoxic zone. As an example, if 45 cm (about 18 inches) diameter fixed orifices are used, 4 orifices can suffice. Having such fixed inter-zone orifices is better than not having them since they would at least provide some means of controlling the retention time in the aerobic and anoxic zones 12 and 14.

However, as mentioned above, it is also desirable to have control of the respective retention times in the aerobic and anoxic treatment zones during influent upheavals and interruptions. Furthermore, it is beneficial to tightly control Dissolved Oxygen in the anoxic zone 14 of the SVMB 24 to better cope with expected and abnormal changing influent characteristics that are common in many wastewater treatment plants.

A better and more responsive approach for controlling the relative retention time of the mixed liquor in the aerobic and anoxic treatment zones 12 and 14 is to use an embodiment of the invention which employs at least one flow rate adjusting device, such as a butterfly valve, for more accurately adjusting the inter-zone flow rate, using a flow rate meter and a Dissolved Oxygen monitor to adjust the gate for precise flow rate control. Indeed, in such an embodiment of the present invention, the bypass flow rate from the aerobic zone to the anoxic zone can be increased when there is lower DO level than allowable and decreased when there is a higher than desired DO level in the anoxic zone.

Dissolved Oxygen monitors are available from a variety of providers. One such DO monitor is the Topac 92-50 from Topac of Hingham, Mass. Another DO monitor is the Strathkelvin 928 six channel input Dissolved Oxygen monitor available from Strathkelvin Instruments, Ltd. of Glasgow, in the U.K. Similarly, flow rate monitors are available from a variety of suppliers. As an example, AccuraFlo monitors are available through Engineered Flow Products, LLC, 8270 South Kyrene Road, Tempe, Ariz. 85284. Gate systems 20 can be obtained from a number of sources, including H. Fontaine Ltd., 1295 Rue Sherbrooke, Magog (Quebec) J1X 2T2 Canada, with options for manual, electric, hydraulic and pneumatic actuation. Other inter-zone flow control valves include butterfly type powered valves, such as the DeZurik BRS electrically powered butterfly valves that can be obtained through DeZurik/Copes-Vulcan, 250 Riverside Avenue North in Sartell, Minn. The BRS butterfly valve is available in sizes ranging from 2 to 36 inches in diameter. Other versions are available from DeZurik for up to 60-inch diameter applications.

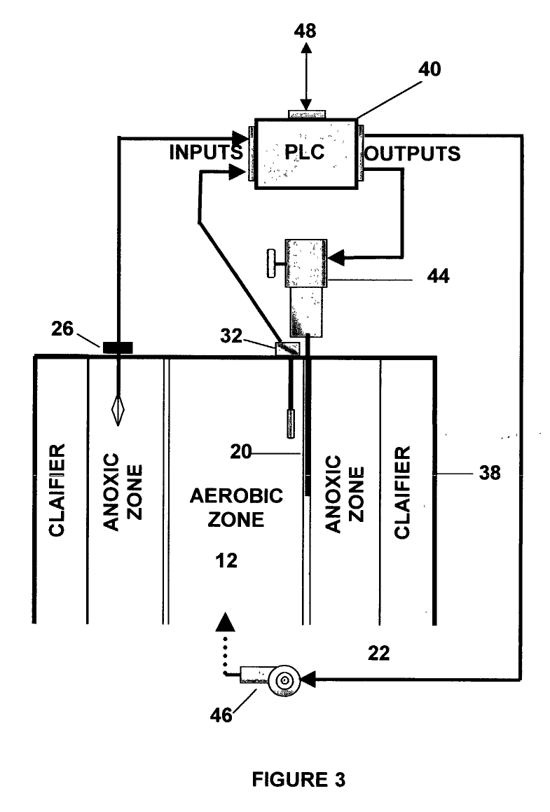

Turning now to FIG. 3 of the appended drawings, a SVMB 38 incorporating an adjustable flow gate system according to an automated embodiment of the instant invention will be described. The influent line (not shown) introduces influent from the top of the vessel into the aerobic zone and the effluent line (not shown) discharges the effluent from the clarifier at the top. In a nutshell, the adjustment of the bypass flow from the upper aerobic zone 12 to its adjacent anoxic zone 14 is automated through the use of a programmable automating controller 40, such as an PLC (Programmable Logic Controller) shown, in response to changing Dissolved Oxygen (DO) within the mixed liquor. The DO level in the anoxic treatment zone 14 is measured using the Dissolved Oxygen monitor 26. It is to be noted that the DO monitor 26 is connected to the controller 40 to supply DO level data.

It is again to be noted that, for clarity purposes, FIG. 3 does not include a depiction of the lower facultative and anaerobic portions of the SVMB or the sludge zone and its sludge rake.

The use of a flow rate monitor 32 supplying flow rate data to the controller 40 allows the rate of inter-zone bypass flow rate to be initially set to achieve the predetermined retention times of the mixed liquor in the aerobic and anoxic treatment zones 12 and 14. Once adjusted, through the use of the programmable automating controller 40, flow rate data from the flow rate monitor 32 can be used to invoke flow control instructions to the inter-zone adjustable gate 20 to foster the desirable average retention times in the aerobic and anoxic zones of the SVMB. More specifically, the opening and closing of the inter-zone gate 20 is controlled by a gate actuator 44 that is itself controlled by the controller 40.

Also shown in FIG. 3 is an adjustable oxygenation blower 46 that is connected to the controller 40 to be controlled thereby in response to the sensed DO level in the anoxic zone and per programmed software instructions.

It is to be noted that since the controller 40 controls the gate actuator 44 and the blower 46, the controller 40 keeps track of its opening and closing commands to inter-zone gate 20 and its speed adjustment commands to blower 46. Alternatively, the actuator 44 and the blower 46 could be provided with sensors (not shown) supplying data to the controller 40.

One skilled in the art would easily understand that the gate actuator 44 could advantageously include a manual override to be used, for example in situations when the electric, hydraulic or pneumatic powering source for actuation is disrupted.

In operation, the controller 40 automates the adjustment of the opening of inter-zone flow control gate 20 through the powered gate actuator 44 from the DO level data supplied by the DO monitor 26 and the flow rate data supplied by the flow rate monitor 32.

As an illustration, the SVMB 38 can be initially set up by first determining the flow gate opening required for maintaining desired average treatment times of illustrative 10 minutes in the aerobic zone 12 and 20 minutes in the anoxic zone 14, according to the above-mentioned ⅓ retention time of the mixed liquor in the aerobic zone and ⅔ retention time in the anoxic zone for adequate processing.

The inter-zone gate 20 is placed with its opening preferably located 1 meter (about 3.3 feet) below the liquid level. The required opening size for the gate 20 is determined as discussed hereinabove. Next, the gate 20 is selected with a maximum opening area that is larger and preferably twice the area necessary for maintaining the aforementioned predetermined retention times in the aerobic and anoxic zones. The controller 40 is then instructed to maintain, as a default setting, an adjustment for the opening of inter-zone gate 20 that corresponds to that required for maintaining predetermined retention times of the mixed liquor in the aerobic and anoxic zones 12 and 14.

All opening and closing adjustments to inter-zone gate 20 are made in reference to its default setting. As discussed hereinabove, data on the position of inter-zone gate 20 is reported to the controller 40 as a reference for adjustments.

Again, the inter-zone aerobic to anoxic flow rate is adjusted by further opening gate 20 from its default setting position when there is a lower than normal Dissolved Oxygen in the anoxic zone 14 and closing gate 20 from its default setting position when there is a higher than normal DO in the anoxic zone 14.

It is to be noted that readings for DO (Dissolved Oxygen) are conventionally taken 1 meter (about 3.3 feet) below the water level and should be in the 0.1 to 0.3 mg/l (milligrams per liter) range for adequate treatment of the mixed liquor. The high and low reference points of DO from which adjustments are instructed by the controller 40 in response to DO changes can be a high DO reference point of 0.3 mg/l and a low DO reference point of 0.1 mg/l.

The extent of opening or closing of the inter-zone gate 20 in response to DO changes from the high and low DO reference points can be programmed into the controller to be proportional to the deviation of the DO from the high and low DO reference points or according to desired algorithms. As an illustration, the controller 40 can be programmed to open the gate 20 fully when the DO level drops below 0.05 mg/l and to open the gate 20 proportionally, for example in 5 steps to reach a fully open position, between 0.1 mg/l and 0.05 mg/l levels of DO, opening one step for each 0.01 mg/l lowering of the DO level below 0.1 mg/l. Similarly, the controller 40 can be programmed to close gate 20 fully when the DO level is higher than 0.5 mg/l and to close the gate 20 proportionally in between 0.3 mg/l and 0.5 mg/l levels of DO, for example closing in 4 steps to reach a fully closed position, closing one step for each 0.05 mg/l increase of DO level above 0.3 mg/l. Thus, controlling the opening of inter-zone gate 20 directly affects the levels of Dissolved Oxygen to be maintained in the anoxic zone according to monitored Dissolved Oxygen levels by DO monitor 26. Normal DO levels also reflect normal retention times in the aerobic and anoxic zones 12 and 14. Data on the position of inter-zone gate 20 is reported to the controller 40 as a reference for adjustments.

Of course, as discussed hereinabove, more than one interzone gate 20 can be used to reduce turbulence at any one inter-zone opening point and maintain better uniformity of the mixed liquor. Multiple inter-zone gates are preferably placed at equal distances around the perimeter of the separating baffle 22, between the upper portions of the aerobic and anoxic zones 12 and 14.

When more than one inter-zone gate 20 is employed, each of the gates can be programmed to respond and open or close in unison with other inter-zone gates. Alternatively, particularly in the case of larger treatment vessels, each of multiple inter-zone gates can be made to open and close independently in response to the anoxic zone DO level in the vicinity of each gate. Of course, if this is the case, multiple DO monitors and gate actuators are provided and independently controlled by the controller 40.

In SVMB plants, Oxygenation blowers, such as oxygenation blower 46 in FIG. 3, are used to directly affect the Dissolved Oxygen levels in the aerobic zone 12 and, through mixed liquor flow around the separating baffle, indirectly affect the DO levels in the anoxic zone 14. The system of the invention provides a more direct means for the oxygenation blower to affect DO levels in the anoxic zone through the direct flow into the anoxic zone of the mixed liquor oxygenated by oxygenation blower 46 any time gate 20 is open.

As discussed hereinabove, the inter-zone gate 20 is set to a default flow rate that fosters the predetermined retention times in the aerobic and anoxic zones 12 and 14. Thus, there is a direct flow of oxygenated mixed liquor from the aerobic zone 12 into the anoxic zone 14. Accordingly, the system of the invention can be advantageously used to coordinate the position of the gate 20 with the output of oxygenation blower 46 to provide direct control of critical DO levels in the anoxic zone 14.

In a possible control algorithm of the controller 40, the controller 40 is so programmed as to favor the Dissolved Oxygen level in the anoxic zone 14 by first controlling the speed (or output) of the oxygenation blower 46. Indeed, this is done by increasing the speed of the blower 46 when DO levels are below normal, up to the maximum allowable RPM (revolutions per minute) of the oxygenation blower 46; and decreasing the speed of oxygenation blower 46 when there is a higher than normal DO level, down to the minimum allowable RPM of oxygenation blower 46.

The controller 40 is further instructed that once the oxygenation blower 46 reaches its minimum or maximum allowable RPM and the DO levels are still not within normal limits as monitored by the DO monitor 26, further adjustments to the DO level in the anoxic zone 14 are carried out by opening and closing flow rate control gate 20 to adjust the rate of inter-zone flow of Oxygen bearing mixed liquor from the aerobic zone to the anoxic zone as discussed hereinabove.

The advantage of instructing the controller 40 to favor adjusting the use of oxygenation blower 46 up to its limits (while maintaining gate 20 at its default flow rate setting) to control DO levels in the anoxic zone 14 is that the default flow rate is maintained steady during normal fluctuations of DO levels, thus maintaining desirable treatment times in the aerobic and anoxic zones. The inter-zone gate 20 is used for further adjustments of DO levels when there are DO fluctuations that are beyond what oxygenation blower 46 and the default flow rate position of gate 20 can address.

While the oxygenation blower 46 is in charge of controlling DO levels, the flow rate monitor 32 can be used to monitor variations from the default flow rate that achieves predetermined retention times in the aerobic and anoxic zones 12 and 14 and to cause the controller 40 to make adjustments to the inter-zone gate 20 position to maintain the default flow rate for the predetermined retention times. However, once the oxygenation blower reaches its maximum or minimum allowable speed, the controller 40 is instructed to place priority on using the inter-zone flow control gate 20 to maintain proper Dissolved Oxygen levels in the anoxic zone 14. Fortunately, in practice, proper Dissolved Oxygen levels in the anoxic zone go hand in hand with proper retention times in the aerobic and anoxic zones and proper retention times in the aerobic and anoxic zones also result in normal DO levels in the anoxic zones. Thus, providing priority to maintaining proper DO levels through adjusting gate 20 also fosters desirable average retention times in the aerobic and anoxic zones.

General-purpose programmable automation controllers, such as programmable logic controllers, are available from a variety of sources. For example, the controller 40 can be a GPC553 general-purpose industrial programmable logic controller made by MicroSHADOW Research, Via Garibaldi, 19020 Ceparana (SP), Italy. The GPC553 PLC uses embedded firmware programming in C, C++, Assembler and other programming languages using DOS or Windows. It interfaces to computers via its RS232 interface. The illustrative GPC553 PLC unit utilizes a Philips 80C552 microcontroller.

It is to be noted that since controllers such as programmable logic controllers, micro-controllers and other general-purpose programmable automation controllers as well as the electronic circuitry generally used to interface to these controllers are believed well known to those skilled in the art, they will not be described in greater details herein.

The controller 40 can be interfaced with one or more supervisory systems (not shown), such as a general-purpose computer (not shown) made by Dell or others, through a network, such as a SCADA (Supervisory Control and Data Acquisition) network (not shown) that is available from Control System Technology, Inc. in Idaho Falls, Id. and other sources. Other commonly used control panels can also be used for supervisory functions, such as a touch screen control panel (not shown) made by Vartech Displays in Baton Rouge, La. and others. Interface to controller 40 is made through interface 48 which can be a data communication port or other interface, depending on the supervisory system desired. When a computer is employed as a supervisory system, data can be stored on its hard drive with time date references. Such a computer can also provide status reports, adjust program instructions to the controller 40 as needed and forward information to remote supervisory facilities, communicating via the Internet, Ethernet, wireless and other available mediums.

It is to be noted that the controller 40 could be itself a general-purpose computer provided with adequate input/output capabilities and adequately programmed.

The following data from two experimental applications of the inter-zone flow control system of the invention illustrates the significant benefits derived in actual field tests.

### EXAMPLE 1

Table 1 below illustrates the substantial improvement in the performance of a slaughterhouse experimental SVMB wastewater treatment plant at Yamachiche in the Quebec province of Canada, with a capacity of 650 cu. meters per day that also co-treats municipal wastewater and employs an experimental inter-zone aerobic to anoxic zone flow control system. The relevant compositions of the effluents of the prior art SVMB wastewater treatment system providing treatment for the slaughterhouse discharge combined with municipal discharge, compared to the effluent of the SVMB employing inter-zone aerobic to anoxic flow control and treating the same discharges are as follows:

TABLE 1

| | | | | | Stabilization |
|---|---|---|---|---|---|
| | | Total | Total | | Time After |
| Effluent | | Suspended | Nitro- | Phos- | Major |
| characteristics | BOD-5 | Solids | gen | phorus | Interruption |
| Without Invention | 29 mg/l | 30 mg/l | 37 mg/l | 37 mg/l | 22 days |
| Average Values | | | | | |
| With Invention | 11 mg/l | 8 mg/l | 12 mg/l | 3 mg/l | 14 days |
| Average Values | | | | | |

As can be concluded from a comparison of the effluent characteristics, BOD (Biochemical Oxygen Demand—also expressed as BOD-5 is a wastewater strength indication unit), total suspended solids, total Nitrogen and Phosphorus levels are greatly improved through the use of the inter-zone flow control system and the stabilization time, after a major interruption (full stoppage), is improved by 8 days.

### EXAMPLE 2

Table 2 below illustrates the improvement in the performance of a food processing SVMB private pilot study plant at McCain Foods in New Brunswick, Canada. In this application, there is the major challenge of constantly changing influent characteristics due to different batches of food produced. After a period of operation, the SVMB wastewater treatment plant employed an experimental inter-zone flow control system. The relevant compositions of the effluents of the prior art pilot SVMB wastewater treatment system with a flow of 2870 liters per day, providing treatment for the discharge of a food processing facility that discharges grease, pizza wastewater, fruit juice production wastewater, potato peels wastewater, French fry wastewater and other food processing wastewater, compared to effluent of the SVMB with the instant invention treating the same discharge are as follows:

TABLE 2

| | | | | | Stabilization |
|---|---|---|---|---|---|
| | | Total | Total | | Time After |
| Effluent | | Suspended | Nitro- | Phos- | Major |
| characteristics | BOD-5 | Solids | gen | phorus | Interruption |
| Without Invention | 33 mg/l | 14 mg/l | 15 mg/l | 15 mg/l | 23 days |
| Average Values | | | | | |
| With Invention | 22 mg/l | 4 mg/l | 9 mg/l | 6 mg/l | 15 days |
| Average Values | | | | | |

Again, as can be concluded from a comparison of the effluent characteristics, BOD-5, total suspended solids, total Nitrogen and Phosphorus levels are greatly improved through the use of the inter-zone flow control system and the stabilization time, after a major interruption (full stoppage), is improved by 8 days.

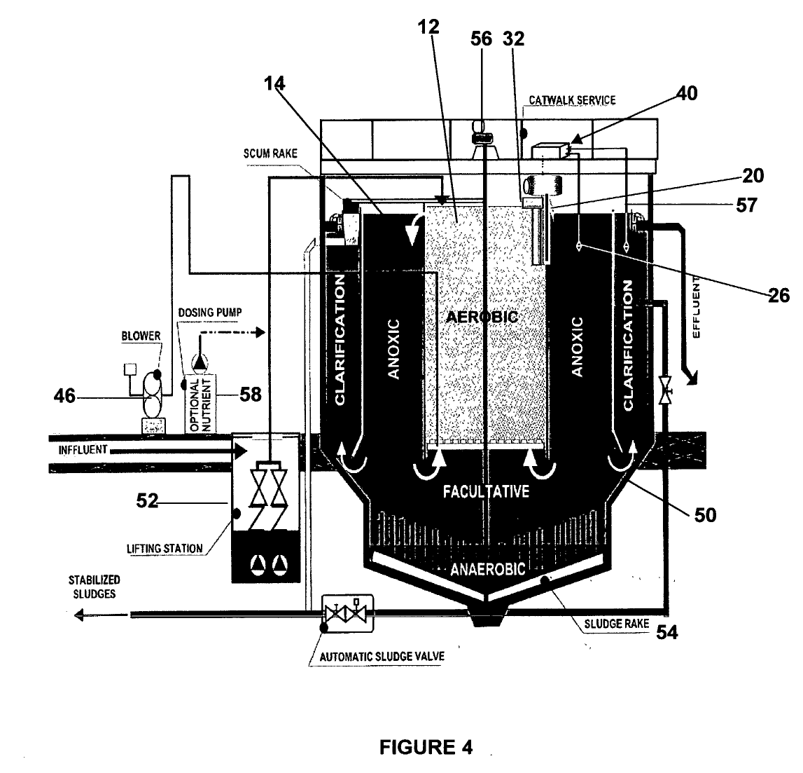

FIG. 4 of the appended drawings is a full vertical sectional view of an SVMB, a single vessel cylindrical multi-zone bioreactor 50 with an upper aerobic zone 12 in the center of the vessel, a concentric adjacent anoxic zone 14 and an outermost concentric clarification zone as shown, together with its support and auxiliary subsystems. The SVMB incorporates an inter-zone flow control system according to an automated and supervised embodiment of the present invention as will be described. It is to be noted that since the interzone flow control system of the SVMB 50 is very similar to the flow control system of the SVMB 38 of FIG. 3, only the differences between these two systems will be described hereinbelow.

The support and auxiliary systems of the SVMB 50 include a lifting station 52 that pumps the influent into the top area of the aerobic zone 12, an oxygenation blower 46 that delivers air to the bottom of the aerobic zone 12 and an internal rotating sludge rake 54 operated by an electric driver 56. Optionally, the SVMB 50 includes an effluent discharge quality-monitoring unit, such as a BOD (Biochemical Oxygen Demand) monitoring unit 57 for the clarification zone of the SVMB that can be used for monitoring the discharge water quality of SVMB 50. BOD monitors are available from a variety of sources. One such monitor is the RACOD Biochemical Oxygen Demand (BOD) meter available from USF Chem Feed Pty, Ltd., Unit A1 6-8 Lyon Park Rd., North Ryde NSW 2113, Australia. The RACOD meter measures BOD and Chemical Oxygen Demand (COD).

Some SVMB plants employ optional nutrients or additives to influence the biological processes in bioreactors. Such optional nutrients and additives are normally injected into the influent line by means of a dosing pump 58. The controller 40 can be used to coordinate the rate of delivery of the optional nutrients or additives to the SVMB 50 with the positioning of the interzone flow gate 20 and output of the oxygenation blower 46 as desired to enhance the plant's performance. For example, delivery of an optional nutrient or additive can be accelerated or decelerated in coordination with the opening position of inter-zone gate 20 and the RPM of oxygenation blower 46 when there are influent upheavals that produce abnormal BOD levels reflected in the clarification zone as measured by BOD monitor 57.

Referring to FIG. 4, data from flow rate monitor 32, DO sensor 26 in the anoxic zone, BOD monitor 57 in the clarification zone, oxygenation blower 46, along with data from optional nutrient dosing pump 58 and other sensors, such as another DO sensor in the aerobic zone (not shown), is input into controller 40 in essentially the same manner as in FIG. 3. Controller 40 provides control outputs for adjusting the opening of inter-zone gate 20, the RPM of oxygenation blower 46 and the dosing rate of optional nutrient dosing pump 58. As in FIG. 3, the interzone-flow control system components that are monitored, coordinated and controlled by controller 40 can be connected and networked by any suitable conventional method, such as a SCADA network (not shown). As also discussed in FIG. 3, controller 40 can be supervised by a supervisory system, such as a computer, which can be networked for providing remote supervision over any suitable medium, such as the internet, Ethernet and wireless networking mediums.

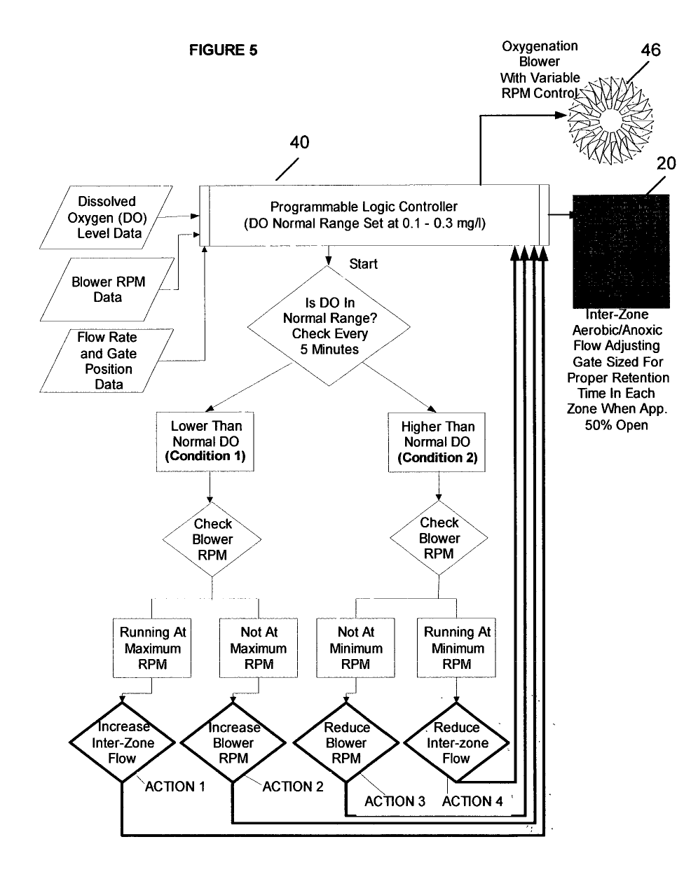

Turning now to FIG. 5 of the appended drawings, a flow chart pertaining to the automated embodiment of the invention will now be described.

FIG. 5 illustrates how a programmable automation controller, such as controller 40, can be configured or programmed for DO level control when control of an inter-zone gate 20 is coordinated with the control of the speed of an oxygenation blower 46.

As discussed hereinabove, the default opening of inter-zone flow control gate of the invention would correspond to the desired average retention times in the aerobic and anoxic zones. Once the default opening is determined, then the inter-zone control gate is selected to have a larger opening, preferably twice the area of the default opening required for desired average retention times in the aerobic and anoxic zones. Inputs into the controller can include blower RPM data, Dissolved Oxygen level, inter-zone flow rate data and gate position data. The flow rate data can be used to make adjustments to the default open position of inter-zone gate during influent changes. In the illustration of FIG. 5, the controller is instructed to check DO levels every five minutes.

Referring to FIG. 5, if the DO level is in the normal range of 0.1 to 0.3 mg/l, then no output is provided and the inter-zone gate remains at its default open setting for fostering desirable average retention times in the aerobic and anoxic zones of the SVMB. Data on the position of inter-zone gate 20 is reported to controller 40 as a reference for adjustments.

If the DO level is below the normal range, then controller 40 is instructed to refer to the RPM data of oxygenation blower 46 to determine whether the oxygenation blower is running at its maximum allowable RPM. If the oxygenation blower 46 is running at a speed below its maximum allowable RPM, then its speed is increased incrementally after each periodic check to provide additional oxygenation. The increments of increasing the blower speed can illustratively be in 250 RPM steps with each 5 minute interval check that indicates that the abnormal DO level has not sufficiently improved. If oxygenation blower 46 is already running at its maximum allowable RPM, then controller 40 instructs the inter-zone gate 20 to incrementally increase its opening. The setting of the increments for opening inter-zone gate 20 can be accomplished as discussed hereinabove with respect to FIG. 3. This process is repeated every five minutes and automated adjustments are made according to monitored conditions until normal DO levels are attained.

If the DO level is above the normal range, then controller 40 is instructed to refer to the oxygenation blower 46 RPM data to determine whether oxygenation blower 46 is running at its minimum allowable RPM. If oxygenation blower 46 is running above its minimum allowable RPM, then its speed is incrementally decreased to provide less oxygenation. The increments of decreasing the blower speed can be in 250 RPM steps with each 5 minute interval check that indicates that the abnormal DO level has not sufficiently improved. If oxygenation blower 46 is already running at its minimum allowable RPM, then controller 40 instructs inter-zone gate 20 to further close its opening incrementally as discussed under FIG. 3. This process is repeated every five minutes and adjustments are made according to monitored conditions until normal DO levels are achieved.

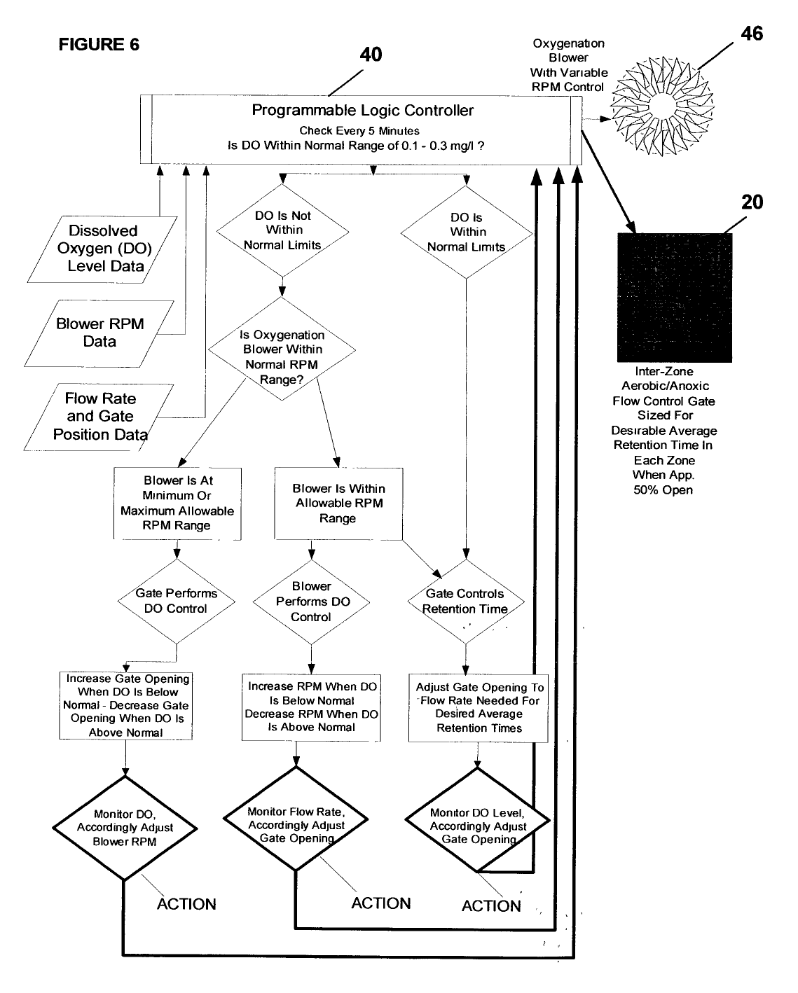

The flow chart of FIG. 6 illustrates how the automated embodiment of the invention can advantageously be employed to coordinate the actions of the inter-zone flow control gate with the oxygenation blower of SVMB plants for a dual purpose of controlling DO levels as a first priority and fostering desirable average retention times in the aerobic and anoxic zones of the SVMB as a second priority. Although DO levels and retention times are related, closely maintaining the desirable Dissolved Oxygen level in the anoxic zone is of higher priority over maintaining desirable average retention times of the mixed liquor in the aerobic and anoxic zones of the SVMB since DO levels profoundly affect the anoxic environment in which critical processing of the mixed liquor is performed.

In FIG. 6, controller 40 receives RPM data for oxygenation blower 46, inter-zone flow rate data from a flow monitor (flow monitor 32 discussed under FIG. 3), data from a DO level monitor (DO level monitor 26 discussed under FIG. 3) and position data from inter-zone gate 20. At regular intervals, for example every 5 minutes, controller 40 is so configured as to update itself on the DO level in the anoxic zone of the SVMB. If the DO level reported is within desirable normal limits (typically 0.1 to 0.3 mg/l), then controller 40 causes the speed of oxygenation blower 46 to remain constant and adjusts the opening of inter-zone gate 20 to foster desirable average retention times in the aerobic and anoxic zones by monitoring and maintaining flow rates that correspond to flow rates that were determined during setup as producing the desired average retention times. Again, data on the position of inter-zone gate 20 is reported to the controller as a reference for adjustments.

If the DO level is reported to controller 40 as not being in the desirable normal range, then controller 40 reads the RPM of oxygenation blower 46 to determine whether it is in its allowable range. If the RPM of oxygenation blower 46 is within its allowable range, then controller 40 instructs oxygenation blower 46 to adjust its speed to a higher increment if the DO level is below normal limits and to a lower increment if the DO level is above normal limits. As discussed hereinabove with respect to FIG. 5, the increments of increase or decrease of the speed of oxygenation blower 46 at each check time can be in 250 RPM increments, continuously variable or as desired. As long as oxygenation blower 46 is managing DO level control, controller 40 adjusts the opening of inter-zone gate 20 to promote desirable average retention times in the aerobic and anoxic zones by monitoring and maintaining flow rates that correspond to flow rates that were determined during setup as producing the desired average retention times.

If the DO level reading is reported not to be in the desirable normal range and data from oxygenation blower 46 reports that the RPM of oxygenation blower 46 is at its minimum or maximum allowable limit, then controller 40 instructs inter-zone gate 20 to widen its opening in increments when the DO level is below the desirable normal limits and to decrease its opening in increments when the DO level is above the desirable normal limits. The actions of inter-zone gate 20 are quite effective and expedient in controlling DO levels, since inter-zone gate 20 adjusts the direct flow rate of Oxygen-laden mixed liquor from the aerobic zone to the anoxic zone. As the DO levels improve following the intervention of inter-zone gate 20, the speed of oxygenation blower 46 is incrementally (at each check time) reverted to its normal mid-range speed. As soon as DO levels within the anoxic zone reach desirable normal limits, controller 40 reverts to the task of adjusting inter-zone gate 20 to foster and control desirable average retention times in the aerobic and anoxic zones of the SVMB in the manner discussed earlier. Controller 40 then instructs oxygenation blower 46 to increase its speed to increase DO levels and decrease its speed to decrease DO levels in the anoxic zone, so long as its speed is within its allowable limits.

One skilled in the art will readily understand that the present invention has, amongst others, the following advantages:

it improves the performance, adaptability and response of SVMB plants for wastewater treatment;

it controls desirable average retention times in the aerobic and anoxic zones of SVMBs to improve overall treatment performance;

it allows for the automation of the process of controlling relative retention times in the aerobic and anoxic zones of SVMBs;

it allows the control of DO levels in the anoxic zone of SVMBs; and

it allows the coordination of the action of the inter-zone flow rate adjustment devices with other auxiliary equipment of an SVMB, including coordination with the speed or output of the oxygenation blower of the SVMB and with the rate of feed of optional nutrients and additives.

As will readily be understood by one skilled in the art, although the above description always refers to the control of the inter-flow gates taking into account the DO in the anoxic zone of the SVMB, it would be possible to design a similar system where other characteristics are taken into account, such as, for example, the BOD in the clarification zone.

Although particular embodiments of the invention have been described herein, the inter-zone aerobic to anoxic zone bypass flow control approach of the invention, as related to SVMB wastewater treatment plants, can be implemented by those skilled in the art with modifications, such as other means of creating inter-zone controlled flow, and with variations taught by this invention due to its inherent versatility. All such modifications and other configurations related to aerobic to anoxic zone inter-zone flow control for DO level control in the anoxic zone, retention time control in the aerobic and anoxic zones and applications thereof that improve stabilization time and performance of SVMB wastewater treatment plants are deemed within the scope and spirit of the invention.

What is claimed is:

1. An inter-zone flow rate control system for single vessel multi-zone bioreactor wastewater treatment plants with horizontally adjacent upper aerobic and anoxic zones; said inter-zone flow rate control system comprising:
at least one flow rate adjusting device provided between the aerobic and anoxic zones; said flow rate adjusting device controlling a flow rate of mixed liquor between the aerobic and anoxic zones;
at least one sensor mounted in the single vessel multi-zone bioreactor to monitor a characteristic thereof;
wherein said flow rate adjusting device is so adjusted as to control the flow rate of the mixed liquor according to data gathered by said at least one sensor.

2. An inter-zone flow rate control system as recited in claim 1, wherein said at least one flow rate adjusting device includes at least one variable opening gate.

3. An inter-zone flow rate control system as recited in claim 2, wherein said at least one variable opening gate is selected from the group consisting of adjustable valves, butterfly valves, sluice valve and iris-type gates.

4. An inter-zone flow rate control system as recited in claim 1, wherein said at least one flow rate adjusting device includes a manually adjustable mechanism.

5. An inter-zone flow rate control system as recited in claim 1, wherein said at least one flow rate adjusting device includes a powered adjustment mechanism.

6. An inter-zone flow rate control system as recited in claim 5, wherein said powered adjustment mechanism is selected from the group consisting of electrically powered adjustment mechanism, pneumatically powered adjustment mechanism and hydraulically powered adjustment mechanism.

7. An inter-zone flow rate control system as recited in claim 1, wherein said at least one sensor includes at least one dissolved oxygen sensor provided in the anoxic zone to measure the level of dissolved oxygen therein.

8. An inter-zone flow rate control system as recited in claim 7, wherein said at least one sensor includes a flow rate sensor so mounted to the single vessel multi-zone bioreactor as to measure the flow of mixed liquor between the aerobic and anoxic zones thereof.

9. An inter-zone flow rate control system as recited in claim 1, wherein said at least one sensor includes a flow rate sensor so mounted to the single vessel multi-zone bioreactor as to measure the flow of mixed liquor between the aerobic and anoxic zones thereof.

10. An inter-zone flow rate control system as recited in claim 1, wherein said at least one sensor includes at least one BOD sensor provided in a clarification zone of the single vessel multi-zone bioreactor.

11. An inter-zone flow rate control system for single vessel multi-zone bioreactor wastewater treatment plants with horizontally adjacent upper aerobic and anoxic zones; said inter-zone flow rate control system comprising:
at least one flow rate adjusting device provided between the aerobic and anoxic zones; said flow rate adjusting device controlling a flow rate of mixed liquor between the aerobic and anoxic zones;
at least one dissolved oxygen sensor mounted in the anoxic zone to monitor a level of dissolved oxygen therein;
wherein said flow rate adjusting device is so adjusted as to control the flow rate of the mixed liquor to keep the level of dissolved oxygen in the anoxic zone within a predetermined range.

12. An inter-zone flow rate control system as recited in claim 11, wherein said predetermined range varies from about 0.1 to about 0.3 mg/l.

13. An inter-zone flow rate control system for single vessel multi-zone bioreactor wastewater treatment plants with horizontally adjacent upper aerobic and anoxic zones; said inter-zone flow rate control system comprising:
at least one flow rate adjusting device provided between the aerobic and anoxic zones; said flow rate adjusting device controlling a flow rate of mixed liquor between the aerobic and anoxic zones;
at least one flow rate sensor so mounted to the single vessel multi-zone bioreactor as to monitor the flow rate between the aerobic and anoxic zones;
wherein said flow rate adjusting device is so adjusted as to control the flow rate of the mixed liquor to keep retention times in the aerobic and anoxic zones at a predetermined ratio.

14. An inter-zone flow rate control system as recited in claim 13, wherein said ratio is about ½.

15. An inter-zone flow rate control system for single vessel multi-zone bioreactor with horizontally adjacent aerobic and anoxic zones; said inter-zone flow rate control system comprising:
a programmable controller;
at least one powered flow rate adjusting device provided between the aerobic and anoxic zones for adjusting a flow rate of mixed liquor between the aerobic and anoxic zones; said flow rate adjusting device being connected to said controller to be controlled thereby;
at least one sensor mounted in the single vessel multi-zone bioreactor to monitor a characteristic thereof; said at least one sensor being connected to said programmable controller to supply characteristic data thereto;
wherein said programmable controller is so configured as to adjust said flow rate adjusting device so that the flow rate of the mixed liquor is controlled in response to the characteristic data gathered by said at least one sensor.

16. An inter-zone flow rate control system as recited in claim 15, wherein said at least one powered flow rate adjusting device includes at least one variable opening gate.

17. An inter-zone flow rate control system as recited in claim 16, wherein said at least one variable opening gate is selected from the group consisting of adjustable valves, butterfly valves, powered sluice valve and iris-type gates.

18. An inter-zone flow rate control system as recited in claim 15, wherein said at least one powered flow rate adjusting device further includes a manually adjustable mechanism.

19. An inter-zone flow rate control system as recited in claim 15, wherein said powered flow rate includes a powered adjustment mechanism selected from the group consisting of electrically powered adjustment mechanism, pneumatically powered adjustment mechanism and hydraulically powered adjustment mechanism.

20. An inter-zone flow rate control system as recited in claim 15, wherein said at least one sensor includes at least one dissolved oxygen sensor provided in the anoxic zone to measure the level of dissolved oxygen therein.

21. An inter-zone flow rate control system as recited in claim 20, wherein said at least one sensor includes at least one flow rate sensor so mounted to the single vessel multi-zone bioreactor as to measure the flow of mixed liquor between the aerobic and anoxic zones thereof.

22. An inter-zone flow rate control system as recited in claim 15, wherein said at least one sensor includes at least one flow rate sensor so mounted to the single vessel multi-zone bioreactor as to measure the flow of mixed liquor between the aerobic and anoxic zones thereof.

23. An inter-zone flow rate control system as recited in claim 15, wherein said at least one sensor includes at least one BOD sensor provided in a clarification zone of the single vessel multi-zone bioreactor.

24. An inter-zone flow rate control system as recited in claim 15 wherein said controller includes a communication interface in communication with a supervisory system

25. An inter-zone flow rate control system as recited in claim 15, wherein said programmable controller includes a Programmable Logic Controller (PLC).

26. An inter-zone flow rate control system as recited in claim 15 wherein said at least one sensor includes at least one dissolved oxygen sensor provided in the anoxic zone to measure the level of dissolved oxygen therein and at least one flow rate sensor so mounted to the single vessel multi-zone bioreactor as to measure the flow of mixed liquor between the aerobic and anoxic zones thereof; wherein said controller is so configured as to control the flow rate of the mixed liquor to keep the level of dissolved oxygen in the anoxic zone within a predetermined range and to keep the retention time in the aerobic and anoxic zones at a predetermined ratio.

27. An inter-zone flow rate control system as recited in claim 15 wherein the single vessel multi-zone bioreactor includes auxiliary equipment connected to said programmable controller to be controlled thereby; said auxiliary equipment being selected from the group consisting of oxygenation blower; nutrient dosing pump and additive dosing pump.

28. An inter-zone flow rate control system for single vessel multi-zone bioreactor with horizontally adjacent aerobic and anoxic zones; the bioreactor being provided with an adjustable oxygenation blower providing oxygen to said aerobic zone; said flow rate control system including:
a programmable controller to which is connected said adjustable oxygenation blower;
at least one powered flow rate adjusting device provided between the aerobic and anoxic zones for adjusting the flow rate of mixed liquor between the aerobic and anoxic zones; said flow rate adjusting device being connected to said controller to be controlled thereby;
at least one dissolved oxygen sensor mounted in the anoxic zone of the single vessel multi-zone bioreactor to monitor the dissolved oxygen level therein; said at least one dissolved oxygen sensor being connected to said programmable controller to provide dissolved oxygen level data thereto;
wherein said programmable controller is so configured as to a) adjust said flow rate adjusting device so that the flow rate of the mixed liquor is controlled in response to the dissolved oxygen level data and b) adjust the oxygenation blower in response to the dissolved oxygen level data.

29. An inter-zone flow rate control system as recited in claim 28, wherein said programmable controller is so configured as to keep the dissolved oxygen level within a predetermined range by first adjusting the oxygenation blower and then, if necessary, adjust said flow rate adjusting device.

30. An inter-zone flow rate control system for single vessel multi-zone bioreactor with horizontally adjacent aerobic and anoxic zones; the bioreactor being provided with an adjustable output oxygenation blower providing oxygen to said aerobic zone; said flow rate control system including:
a programmable controller to which is connected said adjustable oxygenation blower;
at least one powered flow rate adjusting device provided between the aerobic and anoxic zones for adjusting the flow rate of mixed liquor between the aerobic and anoxic zones; said flow rate adjusting device being connected to said controller to be controlled thereby;
at least one dissolved oxygen sensor mounted in the anoxic zone of the single vessel multi-zone bioreactor to monitor the dissolved oxygen level therein; said at least one dissolved oxygen sensor being connected to said programmable controller to provide dissolved oxygen level data thereto;
at least one flow rate sensor so mounted to the single vessel multi-zone bioreactor as to sense the flow rate of liquor between the aerobic and anoxic zones; said at least one flow rate sensor being connected to said programmable controller to provide flow rate data thereto;
wherein said programmable controller is so configured as to a) adjust said flow rate adjusting device so that the flow rate of the mixed liquor is controlled in response to predetermined retention times in the aerobic and anoxic zones and b) adjust the oxygenation blower in response to the dissolved oxygen level data.

31. A process for providing adaptability to changing influent characteristics in single vessel multi-zone bioreactors with an aerobic treatment zone that is horizontally adjacent to an anoxic treatment zone, through controlling the Dissolved Oxygen level in the anoxic treatment zone, said process of controlling the Dissolved Oxygen level in the anoxic treatment zone comprising the acts of:
introducing a flow of mixed liquor from the aerobic treatment zone into the anoxic treatment zone through at least one adjustable opening disposed between the aerobic treatment zone and the anoxic treatment zone;
controlling the flow of mixed liquor from the aerobic treatment zone into the anoxic treatment zone through adjustments of the adjustable opening in accordance with the Dissolved Oxygen level in the anoxic treatment zone.

32. A method for controlling the Dissolved Oxygen level in an anoxic treatment zone of a single vessel multi-zone bioreactors equipped with an adjustable output oxygenation blower, an aerobic treatment zone that is horizontally adjacent to the anoxic treatment zone and at least one Dissolved Oxygen sensor provided in the anoxic treatment zone to monitor the dissolved oxygen level therein, said method comprising the acts of:
introducing a flow of mixed liquor from the aerobic treatment zone into the anoxic treatment zone through at least one adjustable opening disposed between said aerobic treatment zone and said anoxic treatment zone;
adjusting the adjustable output of the oxygenation blower in accordance with the Dissolved Oxygen level in the anoxic zone; increasing in steps the adjustable output for increasing the Dissolved Oxygen level as determined necessary from the Dissolved Oxygen readings to the maximum allowable output of said adjustable output oxygenation blower, and decreasing in steps the adjustable output for decreasing the Dissolved Oxygen level as determined necessary from the Dissolved Oxygen readings to the minimum allowable output of the adjustable output oxygenation blower;
upon said adjustable oxygenation blower output reaching its maximum or minimum allowable output, adjusting the adjustable opening to control the flow of mixed liquor from the aerobic treatment zone into the anoxic treatment zone for controlling the Dissolved Oxygen level; opening the adjustable opening in steps for increasing the Dissolved Oxygen as determined necessary from the Dissolved Oxygen readings and closing the adjustable opening in steps for decreasing the Dissolved Oxygen level as determined necessary from the Dissolved Oxygen level readings.

33. A method for controlling the retention times of mixed liquor in the aerobic treatment zone and the anoxic treatment zone of single vessel multi-zone bioreactors for wastewater treatment where the aerobic treatment zone and the anoxic treatment zones are horizontally adjacent, said method comprising the acts of:
providing at least one adjustable opening disposed between the aerobic treatment zone and the anoxic treatment zone for controlling the rate of inter-zone flow of mixed liquor from the aerobic treatment zone into the anoxic treatment zone;
monitoring said rate of inter-zone flow of mixed liquor from the aerobic treatment zone into the anoxic treatment zone; and
adjusting the adjustable opening for controlling the rate of the inter-zone flow in accordance with the flow rate information to control the retention time of the mixed liquor in the aerobic treatment zone and in the anoxic treatment zone.
